(19) United States
(12) Patent Application Publication
(10) Pub. No.: US 2009/0310532 A1
(43) Pub. Date: Dec. 17, 2009

(54) METHOD AND APPARATUS FOR OBTAINING AN ADDRESS ASSOCIATED WITH A NEIGHBOURING CELL OF A CELLULAR COMMUNICATION NETWORK

(75) Inventor: DAVID NEIL, Cambridge (GB)

Correspondence Address: AKERMAN SENTERFITT, P.O. BOX 3188, WEST PALM BEACH, FL, 33402-3188, US

(73) Assignee: IP.ACCESS LIMITED, Cambridge (GB)

(21) Appl. No.: 12/137,094

(22) Filed: Jun. 11, 2008

(51) Int. Cl. H04Q 7/00; H04Q 7/20

(52) U.S. Cl. 370/328; 455/436; 455/550.1

(57) ABSTRACT

A network element (110) for supporting communications in a communication cell of a cellular communication network (100) can comprise transceiver circuitry arranged to enable communication with one or more wireless communication units (114) located within the general vicinity of the communication cell, and signal processing logic. The signal processing logic is arranged to read (220) system information broadcast within a neighbouring cell, construct (230) a Fully Qualified Domain Name (FQDN) using the read system information, and to obtain (240) an address associated with the constructed FQDN.

### FIELD OF THE INVENTION

The field of the invention relates to a method and apparatus for obtaining an address associated with a neighbouring cell of a cellular communication network, and in particular to a method and apparatus for obtaining an address for an access point of a neighbouring femto cell in order to enable a connection to be established therewith.

### BACKGROUND OF THE INVENTION

Wireless communication systems, such as the 3^{rd} Generation (3G) of mobile telephone standards and technology, are well known. An example of such 3G standards and technology is the Universal Mobile Telecommunications System (UMTS), developed by the 3^{rd} Generation Partnership Project (3GPP) (www.3gpp.org).

Typically, wireless communication units, or User Equipment (UE) as they are often referred to in 3G parlance, communicate with a Core Network (CN) of the 3G wireless communication system via a Radio Network Subsystem (RNS). A wireless communication system typically comprises a plurality of radio network subsystems, each radio network subsystem comprising one or more cells to which UEs may attach, and thereby connect to the network.

The 3^{rd} generation of wireless communications has been developed for macro-cell mobile phone communications. Such macro cells utilise high power base stations (referred to as NodeBs in 3GPP parlance) to communicate with UEs within a relatively large coverage area.

Lower power (and therefore smaller coverage area) femto cells or pico-cells are a recent development within the field of wireless cellular communication systems. Femto cells or pico-cells (with the term femto cells being used hereafter to encompass pico-cells or similar) are effectively communication coverage areas supported by low power base stations (otherwise referred to as Access Points (APs)). These femto cells are intended to be able to be piggy-backed onto the more widely used macro-cellular network and thereby support communications to UEs in a restricted, for example ‘in-building’, environment.

In this regard, a femto cell that is intended to support communications according to the 3GPP standard will hereinafter be referred to as a 3G femto cell. Similarly, an access controller intended to support communications with a low power base station in a femto cell according to the 3GPP standard will hereinafter be referred to as a 3^{rd} generation access controller (3G AC). Similarly, an Access Point intended to support communications in a femto cell according to the 3GPP standard will hereinafter be referred to as a 3^{rd} Generation Access Point (3G AP).

Typical applications for such femto cell APs include, by way of example, residential and commercial (e.g. office) locations, ‘hotspots’, etc, whereby an AP can be connected to a core network via, for example, the Internet using a broadband connection or the like. In this manner, femto cells can be provided in a simple, scalable deployment in specific in-building locations where, for example, network congestion at the macro-cell level may be problematic.

In a femto cell network, it is often desirable for femto cell APs to be able to communicate with one another, thereby facilitating the handover of UEs between femto APs, to coordinate auto configuration algorithms in order to avoid positive feedback loops, etc. Additionally, communication between APs further enables the establishment of connections for the purpose of media routing between APs, and to enable coordination of neighbour cell lists, etc.

The ability for femto cell APs to communicate between themselves may further be used to receive a wide variety of information from neighbouring cells, thereby enabling such opportunities as validating a location of an AP, by way of monitoring location information (e.g. longitude and latitude information) received from neighbouring cells, identifying neighbouring cells within a common group based on, say, group ID information received from neighbouring cells, interference minimisation by way of receiving common pilot channel (CPICH) power selection algorithm information from neighbouring cells, etc.

Currently, although no specific standard technique for providing a mechanism for enabling femto cells to communication with each other has been defined, work in this area to date has assumed that such inter-AP communication will be provided over a backhaul connection.

One option considered for establishing a connection between femto cell APs within a common Network Operator domain comprises configuring each 3G AP with the necessary information for establishing a connection with other 3G APs in its vicinity, such as, by way of example, internet protocol (IP) addresses of neighbouring 3G APs or their controllers. However, this assumes that the Network Operator knows the geographical location of the 3G APs within its domain, and, thus, is able to configure each 3G AP with the necessary information for those 3G APs in its vicinity.

For macro-cellular parts of a network, determining the location of a cell is typically not an issue, since the Network Operator would have been responsible for the installation of the various base stations, and therefore planning the locations of the macro-cells. However, it is often the case that femto cells are not planned, or indeed installed, by the Network Operator. Consequently, although the owner of the femto cell may know the precise location of the femto cell, it is regularly the case that the Network Operator is unaware of the specific location of the femto cell. Hence, it is unrealistic to depend on the Network Operator to be able to reliably configure each 3G AP with the necessary information for establishing a connection with other 3G APs in its vicinity. Furthermore, such a solution requires an Operator controlled central configuration database, the provision of which would be time consuming and would still fail to address cross operator domain communication for 3G APs.

Thus, there exists a need for an apparatus and a method for obtaining an address associated with a neighbouring cell of a cellular communication network that substantially alleviates at least some of the deficiencies with current techniques and methods therefor.

### SUMMARY OF THE INVENTION

Accordingly, the invention seeks to mitigate, alleviate or eliminate one or more of the abovementioned disadvantages singly or in any combination.

According to a first aspect of the invention, there is provided a network element for supporting communications in a communication cell of a cellular communication network. The network element comprises transceiver circuitry arranged to enable communication with one or more wireless communication units located within the general vicinity of the communication cell, and signal processing logic. The signal processing logic is arranged to read information that is broadcast within a neighbouring cell, construct a Fully Qualified Domain Name (FQDN) using the read information, and obtain an address associated with the constructed FQDN.

In this manner, the network element is able to obtain an address for a neighbouring cell, substantially alleviating the need for a Network Operator to configure the network element with the addresses for neighbouring cells. In particular, the use of a FQDN enables an address associated with a neighbouring cell to be obtained using existing mechanisms, for example available by way of the Internet, as described in greater detail below. Thus, by defining a mapping to convert system information elements into FQDNs for elements within a cellular network, and using an FQDN to obtain an address for the neighbouring cell the need for the network element to query a network operator's internal system (such as a central configuration database), or a cross Operator Domain management system is substantially alleviated.

According to a second aspect of the invention, there is provided a method for obtaining an address associated with a neighbouring cell of a cellular communication network. The method comprises the steps of reading system information broadcast within the neighbouring cell, constructing a Fully Qualified Domain Name (FQDN) using the read system information, and obtaining an address associated with the constructed FQDN.

According to a third aspect of the invention, there is provided a wireless communication system adapted to support the aforementioned method for obtaining an address associated with a neighbouring cell of a cellular communication network.

According to a fourth aspect of the invention, there is provided a computer-readable storage element having computer-readable code stored thereon for programming signal processing logic to perform the aforementioned method for obtaining an address associated with a neighbouring cell of a cellular communication network.

These and other aspects, features and advantages of the invention will be apparent from, and elucidated with reference to, the embodiment(s) described hereinafter.

### BRIEF DESCRIPTION OF THE DRAWINGS

Embodiments of the invention will be described, by way of example only, with reference to the accompanying drawings, in which:

FIG. 1 illustrates an example of part of a cellular communication network adapted in accordance with an embodiment of the invention;

FIG. 2 illustrates an example of a simplified flowchart of a method for obtaining an address associated with a neighbouring cell of a cellular communication network in accordance with some embodiments of the invention; and

FIG. 3 illustrates a typical computing system that may be employed to implement signal processing functionality in embodiments of the invention.

### DETAILED DESCRIPTION OF EMBODIMENTS OF THE INVENTION

Although not mentioned in any public forum or document to the knowledge of the inventor, it is envisaged that an alternative option for establishing a connection between femto cell 3G APs within a common Network Operator domain may be to enable each 3G AP to detect, or ‘see’, a neighbouring cell, and to query a Network Operator's internal system, such as a central configuration database, to identify the appropriate controller for the detected neighbouring cell. In this manner, the Network Operator is not required to know the specific locations of every 3G AP. Instead, 3G APs may request, or lookup in the central database, the information they require, such as an IP address for the appropriate controller, in order contact the appropriate controller over the backhaul. In this manner, a 3G AP is able to obtain the required information for establishing a connection with a neighbouring 3G AP from the controller for that 3G AP.

However, a problem with such a solution would be that it requires an Operator-controlled central configuration database, and is not appropriate for cross operator domain communication for 3G APs.

It is also envisaged by the inventor that a further option for establishing a connection between femto cell 3G APs may comprise enabling each 3G AP to ‘listen’ for neighbouring cells, and upon seeing a neighbouring cell, for the AP to query a central, cross Operator Domain management system to find the appropriate controller. However, such a solution would require standardisation of the management system across multiple Network Operators. As history has shown, whilst standardisation of signalling has been successful, standardisation of any management systems has never been achieved. Thus, such a solution is unlikely to be workable.

Embodiments of the invention propose an alternative mechanism for addressing the aforementioned problems.

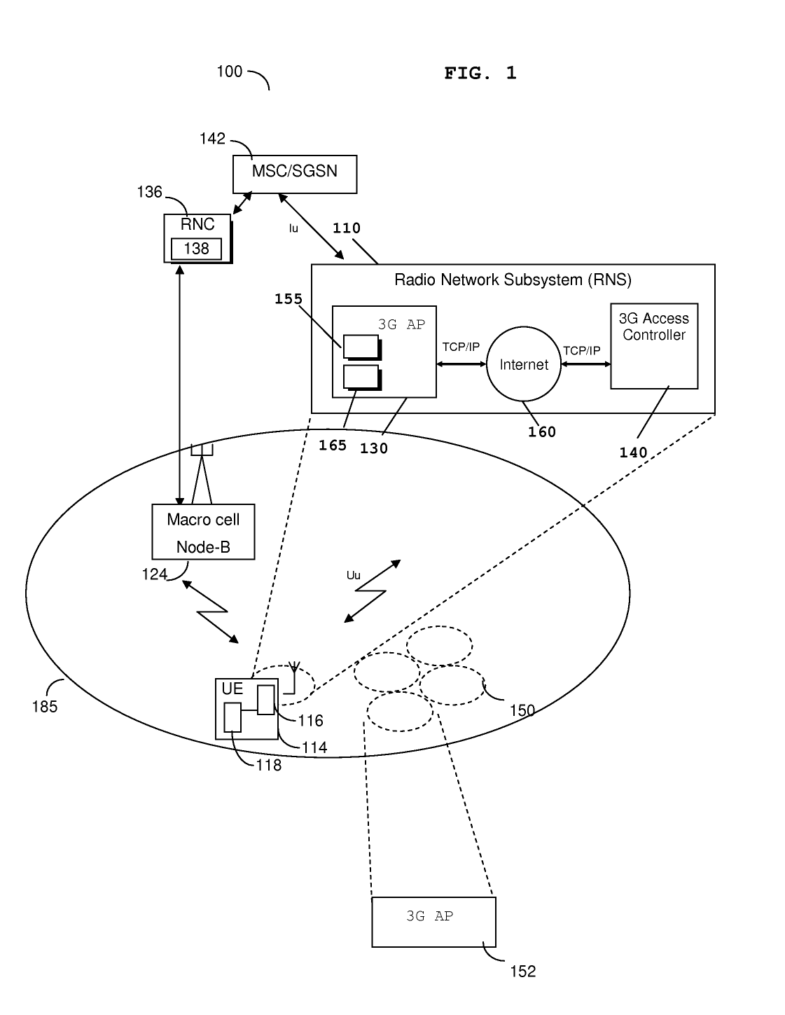

Referring now to the drawings, and in particular FIG. 1, an example of part of a 3GPP network, adapted in accordance with an embodiment of the invention, is illustrated and indicated generally at 100. In FIG. 1, there is illustrated an example of a communication system 100 that comprises a combination of a macro cell 185 and a plurality of 3G femto cells 150 in accordance with one embodiment of the invention. For the embodiment illustrated in FIG. 1, the radio network sub-system (RNS) comprises two distinct architectures to handle the respective macro cell and femto cell communications. In the macro cell scenario, the RNS comprises a controller in the form of a Radio Network Controller (RNC) 136 having, inter alia, signal processing logic 138. The RNC 136 is operably coupled to a Node B 124 for supporting communications within the macro cell 185. The RNC 136 is further operably coupled to a core network element 142, such as a serving General Packet Radio System (GPRS) support node (SGSN)/mobile switching centre (MSC), as known.

In a femto cell scenario, an RNS 110 comprises a network element, in a form of a 3G Access Point (3G AP) 130, arranged to perform a number of functions generally associated with a base station, and a controller in a form of a 3G Access controller (3G AC) 140. As will be appreciated by a skilled artisan, a 3G Access Point is a communication element that supports communications within a communication cell, such as a 3G femto cell 150, and as such provides access to a cellular communication network via the 3G femto cell 150. One envisaged application is that a 3G AP 130 may be purchased by a member of the public and installed in their home. The 3G AP 130 may then be connected to a 3G AC 140 over the owner's broadband internet connection 160.

Thus, a 3G AP 130 may be considered as encompassing a scalable, multi-channel, two-way communication device that may be provided within, say, residential and commercial (e.g. office) locations, ‘hotspots’ etc, to extend or improve upon network coverage within those locations. Although there are no standard criteria for the functional components of a 3G AP, an example of a typical 3G AP for use within a 3GPP system may comprise some Node-B functionality and some aspects of radio network controller (RNC) 136 functionality. The 3G AP 130 further comprises transceiver circuitry 155 arranged to enable communication with one or more wireless communication units located within the general vicinity of the communication cell, and in particular within the communication cell 150, such as User Equipment (UE) 114, via a wireless interface (Uu).

The 3G Access Controller 140 may be coupled to the core network (CN) 142 via an Iu interface, as shown. In this manner, the 3G AP 130 is able to provide voice and data services to a cellular handset, such as UE 114, in a femto cell in contrast to the macro cell, in the same way as a conventional Node-B, but with the deployment simplicity of, for example, a Wireless Local Area Network (WLAN) access point.

The UE 114 is a wireless communication unit comprising a transceiver 116 arranged to transmit and receive signals, and signal processing logic 118. As would be appreciated by a skilled person, UE 114 comprises numerous other functional and logical elements to support wireless communications and functionality and which will not be described further herein.

As previously mentioned, it is often desirable for network elements such as femto cell APs to be able to communicate with one another, facilitating the handover of UEs between femto APs, to coordinate auto configuration algorithms in order to avoid positive feedback loops, etc. Additionally, communication between APs further enables the establishment of connections for the purpose of media routing between APs, and to enable coordination of neighbour cell lists, etc.

In accordance with some embodiments of the invention, the 3G AP 130 comprises signal processing logic 165 arranged to read system information broadcast within a neighbouring cell, construct a Fully Qualified Domain Name (FQDN) using the read system information, and to obtain an address associated with the constructed FQDN.

In this manner, the 3G AP 130 is able to obtain an address for a neighbouring cell, substantially alleviating the need for a Network Operator to configure the 3G AP with the addresses for neighbouring cells. In particular, the use of a FQDN enables an address associated with a neighbouring cell to be obtained using existing mechanisms, for example available by way of the Internet, as described in greater detail below. Thus, using an FQDN to obtain an address for the neighbouring cell substantially alleviates the need for the 3G AP 130 to query a network operator's internal system (such as a central configuration database), or a cross Operator Domain management system.

As will be appreciated by a skilled artisan, an FQDN is an unambiguous domain name that specifies the exact location in the Domain Name System's tree structure through to a top-level domain and the root domain. More detail and information about FQDNs may be found at http://en.wikipedia.org/wiki/Fqdn. More detailed information relating to the Domain Name System can be found at http://en.wikipedia.org/wiki/Domain_Name_System.

As will also be appreciated by a skilled artisan, with a UMTS network, system information may be broadcast within cells by way of system information messages. More particularly, a UMTS network utilises a Radio Resource Control (RRC) protocol. The RRC protocol is defined in the Universal Mobile Telecommunications System (UMTS) Radio Resource Control (RRC) Protocol specification (3GPP TS 25.331), and forms part of the network layer between the UE and the UMTS Terrestrial Radio Access Network (UTRAN). The RRC protocol comprises connection management procedures, which, in turn, comprise the broadcasting of system information by the UTRAN.

More particularly, system information elements are broadcast in system information blocks, which group together system information elements of the same nature. A generic ‘SYSTEM INFORMATION’ message is used to convey the system information blocks on a BCCH (Broadcast Control CHannel) logical channel, which, in turn, may be mapped onto either a BCH (Broadcast CHannel) or FACH (Forward Access CHannel) transport channel. The size of the SYSTEM INFORMATION message is configured to fit the size of a BCH or FACH transport block, as required.

The RRC layer in the UTRAN performs segmentation and concatenation of encoded system information blocks. If the encoded system information block is larger than the size of a SYSTEM INFORMATION message, it is segmented and transmitted in several messages. If the encoded system information block is smaller than a SYSTEM INFORMATION message, several system information blocks may be concatenated into the same SYSTEM INFORMATION message. Notably, the System Information messages contain information that is broadcast by a cell and can be received by anyone listening to the cell, as clarified in 3GPP TS 25.331.

Typically, System Information messages contain information that is common to all of the UEs in the cell, and is intended for reception by the UEs within the cell. However, in accordance with some embodiments of the invention, it is contemplated that information broadcast within System Information messages may be read and used by neighbouring 3G APs or Node-Bs in order to construct FQDNs as described in greater detail below.

It is envisaged that embodiments of the invention are not limited to the use of system information broadcast within system information messages as described above. For example, the signal processing logic 155 may alternatively be arranged to read information broadcast within a Broadcast/Multicast Control (BMC) message, such as a Cell Broadcast Service (CBS) message, defined in the Broadcast/Multicast Control (BMC) Technical Specification (3GPP TS 25.324). For example, within the current 3GPP standards, CBS messages carry cell broadcast data etc. from a Cell Broadcast Centre to a UE. In particular, CBS messages are broadcast within a Common Traffic CHannel (CTCH), a CTCH block set forming a subset of the transport block set of the Forward Access Channel (FACH). In the same manner as for system information messages, BMC messages typically contain information that is common to all of the UEs in the cell, and is intended for reception by the UEs within the cell. However, in accordance with some embodiments of the invention, it is contemplated that information broadcast within BMC messages directed to UEs located and operational within the cell may be read and used by neighbouring 3G APs or Node-Bs in order to construct FQDNs as described in greater detail below.

For simplicity, the term ‘system information’ will hereinafter be used to refer generically to information broadcast within, say, a neighbouring cell and directed to use by UEs operational within that neighbouring cell that may be used additionally by neighbouring 3G APs or Node-Bs to construct an FQDN as described in greater detail below. In particular, the term ‘system information’ may refer to information broadcast within a system information message and/or a Broadcast/Multicast Control message as described above.

Referring back to the embodiment illustrated in FIG. 1, the signal processing logic 155 of the 3G AP 130 is arranged to construct an FQDN using the system information broadcast within the neighbouring cell. In accordance with some embodiments of the invention, it is proposed to define a mapping to convert system information elements into FQDNs for elements within a cellular network.

As will be appreciated by a skilled artisan, within each cell of a UMTS network, system information in a form of a mobile country code (MCC) and/or mobile network code (MNC) is broadcast, thereby identifying the country and network for that particular cell. Furthermore, a Cell Global Identifier (CGI) is also transmitted within the system information of each cell. Typically, the CGI for a cell comprises a 12-bit Controller Identity (RNC ID), which uniquely identifies the controller within the network, and a 16-bit Cell Identity (Cell ID), which uniquely identifies the cell with respect to the controller.

In one embodiment of the invention, it is envisaged that a Location Area Code (LAC) and/or a Routing Area Code (RAC) may also be used. Although such values may not uniquely address a cell, it is envisaged that they may be used to identify a controller.

Thus, and in accordance with some embodiments of the invention, a mapping is defined to convert, for example, the MCC, MNC, RNC ID and Cell ID of a cell into an FQDN for that cell. Accordingly, the signal processing logic 155 of the 3G AP 130 illustrated in FIG. 1 may be arranged to read the MCC, MNC, RNC ID and Cell ID for the neighbouring cell, and to use these read values to construct the FQDN for the neighbouring cell. The FQDN may comprise a general format of ‘CellID_val.RNCID_val.MNC_val.MCC_val’, wherein:
CellID_val represents a value based on the Cell ID for the neighbouring cell;
RNCID_val represents a value based on the RNC ID for the controller of the neighbouring cell;
MNC_val represents a value based on the MNC for the network of the neighbouring cell; and
MCC represents a value based on the MCC for the country of the neighbouring cell.

For example, a neighbour cell may be transmitting the system information values of:
MCC=001
MNC=01
RNC ID=120
Cell ID=2345

Accordingly, the FQDN used to communicate with the neighbour cell may be mapped to:
FQDN=cell2345.rnc120.mnc01.mcc001

In this manner, the signal processing logic 155 is then able to use the constructed FQDN to obtain the address for the 3G AP 152 supporting the neighbouring cell 150. The signal processing logic 155 is then able, and may be arranged, to contact the address of the 3G AP 152 supporting the neighbouring cell 150 using the obtained address.

As will be appreciated by a skilled artisan, it may not always be possible to obtain an address for a neighbouring cell, or to contact a network element supporting a neighbouring cell directly. Thus, and according to some alternative embodiments of the invention, the signal processing logic 155 of the 3G AP 130 illustrated in FIG. 1 may be arranged to read the MCC, MNC, and RNC ID for the neighbouring cell, and to use these read values to construct the FQDN for the controller of the neighbouring cell. Accordingly, the FQDN may comprise a general format of ‘RNCID_val.MNC_val.MCC_val’, wherein:
RNCID_val represents a value based on the RNC ID for the controller of the neighbouring cell;
MNC_val represents a value based on the MNC for the network of the neighbouring cell; and
MCC_val represents a value based on the MCC for the country of the neighbouring cell.

For example, in this embodiment, a neighbour cell may be transmitting the system information values of, say:
MCC=‘001’
MNC=‘01’
RNC ID=‘120’

Accordingly, the FQDN for the controller may be mapped to:
FQDN=rnc120.mnc01.mcc001

In this manner, the signal processing logic 155 is then able to use the constructed FQDN to obtain the address for the controller (not shown) of the neighbouring cell 150. The signal processing logic 155 is then able, and may be arranged, to contact the address of the controller of the neighbouring cell 150 using the obtained address, and thereby obtain information with which the 3G AP 130 is able to establish a connection with the, say, 3G AP 152 of FIG. 1 via the IP network. It is envisaged that this connection may be effected directly to the neighbour cell, or may be effected via the controller of the neighbour cell.

In accordance with some embodiments of the invention, the address associated with the FQDN, and obtained by the signal processing logic 155, may comprise a network address, such as an Internet Protocol (IP) address. Accordingly, the signal processing logic 155 may be arranged to obtain the IP address by performing a Domain Name System (DNS) lookup, whereby the FQDN may be translated into the appropriate IP address.

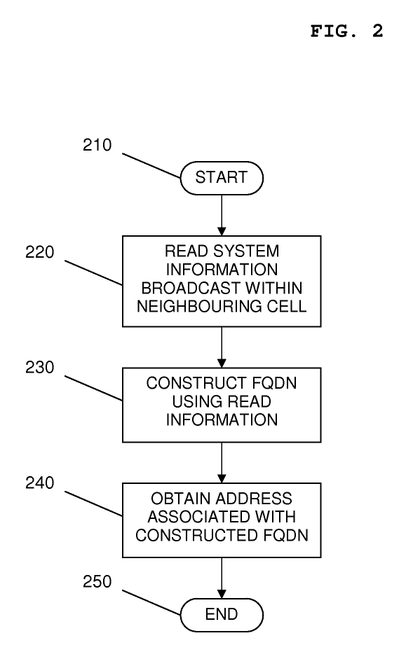

Referring now to FIG. 2, there is illustrated an example of a simplified flowchart 200 of a method for obtaining an address associated with a neighbouring cell of a cellular communication network according to some embodiments of the invention.

The method starts at step 210, and moves to step 220 with a 3G AP reading system information broadcast within at least one neighbouring macro, or femto cell. Next, in step 230, an FQDN is constructed by the 3GAP using the read system information. An address is then obtained, in step 240, associated with the constructed FQDN by, performing a Domain Name System (DNS) lookup and the method ends at step 250.

In some embodiments of the invention, it is envisaged that the dynamic aspects of appearing/disappearing femto cells may be handled by periodically listening for neighbour cells to determine whether any status or activity has changed. The process described herein may then be performed for each new neighbour cell.

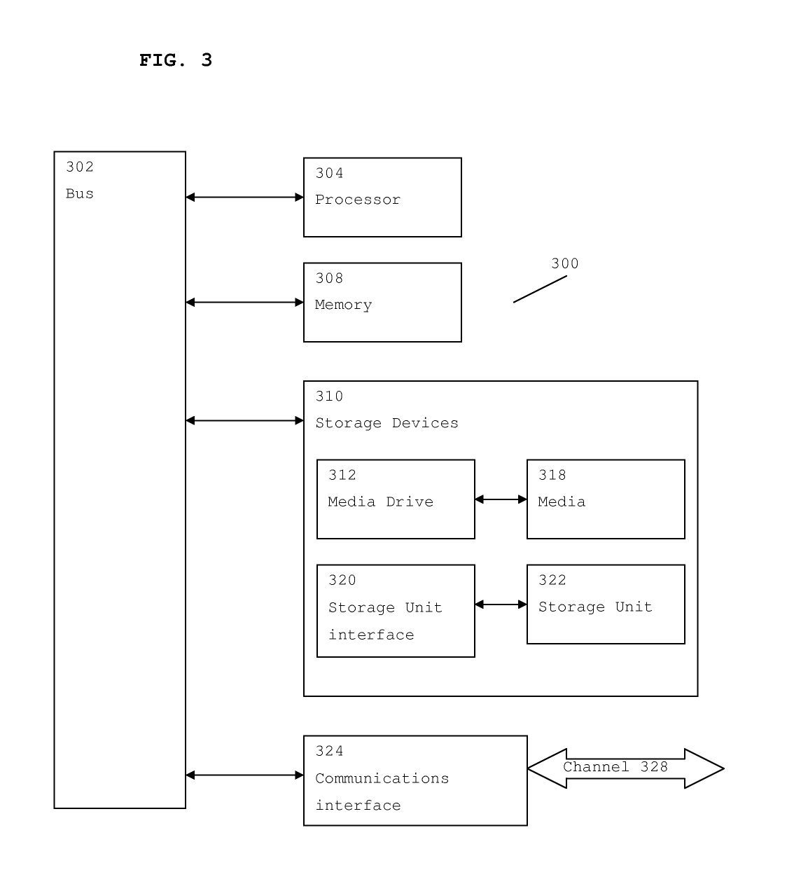

Referring now to FIG. 3, there is illustrated a typical computing system 300 that may be employed to implement signal processing functionality in embodiments of the invention. Computing systems of this type may be used in access points and wireless communication units. Those skilled in the relevant art will also recognize how to implement the invention using other computer systems or architectures. Computing system 300 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 300 can include one or more processors, such as a processor 304. Processor 304 can be implemented using a general or special-purpose processing engine such as, for example, a microprocessor, microcontroller or other control logic. In this example, processor 304 is connected to a bus 302 or other communications medium.

Computing system 300 can also include a main memory 308, such as random access memory (RAM) or other dynamic memory, for storing information and instructions to be executed by processor 304. Main memory 308 also may be used for storing temporary variables or other intermediate information during execution of instructions to be executed by processor 304. Computing system 300 may likewise include a read only memory (ROM) or other static storage device coupled to bus 302 for storing static information and instructions for processor 304.

The computing system 300 may also include information storage system 310, which may include, for example, a media drive 312 and a removable storage interface 320. The media drive 312 may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive. Storage media 318 may include, for example, a hard disk, floppy disk, magnetic tape, optical disk, CD or DVD, or other fixed or removable medium that is read by and written to by media drive 312. As these examples illustrate, the storage media 318 may include a computer-readable storage medium having particular computer software or data stored therein.

In alternative embodiments, information storage system 310 may include other similar components for allowing computer programs or other instructions or data to be loaded into computing system 300. Such components may include, for example, a removable storage unit 322 and an interface 320, such as a program cartridge and cartridge interface, a removable memory (for example, a flash memory or other removable memory module) and memory slot, and other removable storage units 322 and interfaces 320 that allow software and data to be transferred from the removable storage unit 322 to computing system 300.

Computing system 300 can also include a communications interface 324. Communications interface 324 can be used to allow software and data to be transferred between computing system 300 and external devices. Examples of communications interface 324 can include a modem, a network interface (such as an Ethernet or other NIC card), a communications port (such as for example, a universal serial bus (USB) port), a PCMCIA slot and card, etc. Software and data transferred via communications interface 324 are in the form of signals which can be electronic, electromagnetic, and optical or other signals capable of being received by communications interface 324. These signals are provided to communications interface 324 via a channel 328. This channel 328 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms ‘computer program product’ ‘computer-readable medium’ and the like may be used generally to refer to media such as, for example, memory 308, storage device 318, or storage unit 322. These and other forms of computer-readable media may store one or more instructions for use by processor 304, to cause the processor to perform specified operations. Such instructions, generally referred to as ‘computer program code’ (which may be grouped in the form of computer programs or other groupings), when executed, enable the computing system 300 to perform functions of embodiments of the invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 300 using, for example, removable storage unit 322, drive 312 or communications interface 324. The control logic (in this example, software instructions or computer program code), when executed by the processor 304, causes the processor 304 to perform the functions of the invention as described herein.

It will be appreciated that, for clarity purposes, the above description has described embodiments of the invention with reference to different functional elements and processors. However, it will be apparent that any suitable distribution of functionality between different functional elements or processors, for example with respect to the base station or controller, may be used without detracting from the invention. For example, it is envisaged that functionality illustrated to be performed by separate processors or controllers may be performed by the same processor or controller. Hence, references to specific functional units are only to be seen as references to suitable means for providing the described functionality, rather than indicative of a strict logical or physical structure or organization.

Aspects of the invention may be implemented in any suitable form including hardware, software, firmware or any combination of these. The invention may optionally be implemented, at least partly, as computer software running on one or more data processors and/or digital signal processors. Thus, the elements and components of an embodiment of the invention may be physically, functionally and logically implemented in any suitable way. Indeed, the functionality may be implemented in a single unit, in a plurality of units or as part of other functional units.

Although one embodiment of the invention describes an AP for UMTS network, it is envisaged that the inventive concept is not restricted to this embodiment.

Although the invention has been described in connection with some embodiments, it is not intended to be limited to the specific form set forth herein. Rather, the scope of the invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Moreover, an embodiment can be implemented as a computer-readable storage element having computer readable code stored thereon for programming a computer (e.g., comprising a signal processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’ etc. do not preclude a plurality.

Thus, a method and apparatus for obtaining an address associated with a neighbouring cell of a cellular communication network have been described, which substantially addresses at least some of the shortcomings of past and present cell location techniques and/or mechanisms.

I claim:

1. A network element for supporting communications in a communication cell of a cellular communication network, the network element comprising:
transceiver circuitry arranged to enable communication with one or more wireless communication units located within the communication cell; and
signal processing logic operably coupled to the transceiver circuitry,
wherein the signal processing logic is arranged to:
read information broadcast within a neighbouring cell;
construct a Fully Qualified Domain Name (FQDN) using the read information; and
obtain an address associated with the constructed FQDN.

2. The network element of claim 1 wherein the signal processing logic is arranged to construct an FQDN using system information broadcast within a system information message of the neighbouring cell.

3. The network element of claim 2 further characterised in that the system information with which the FQDN is constructed comprises at least one from a group of:
a mobile country code (MCC);
a mobile network code (MNC);
a Controller Identity (RNC ID);
a Cell Identity (Cell ID);
a Location Area Code (LAC);
a Routing Area Code (RAC).

4. The network element of claim 1 further characterised in that the signal processing logic is arranged to construct an FQDN for a controller of the neighbouring cell.

5. The network element of claim 3 further characterised in that the signal processing logic is arranged to construct an FQDN comprising a combination of RNC ID, MNC, MCC.

6. The network element of claim 5 further characterised in that the signal processing logic is arranged to construct an FQDN comprising additionally a cell identity.

7. The network element of claim 5 further characterised in that the neighbouring cell comprises a femto cell, and the network element supporting the neighbouring cell comprises an Access Point (AP) therefor.

8. The network element of claim 1 further characterised in that the address associated with the FQDN comprises a network address.

9. The network element of claim 8 further characterised in that the network address associated with the FQDN comprises an Internet Protocol (IP) address.

10. The network element of claim 9 further characterised in that the signal processing logic is arranged to obtain the IP address by performing a Domain Name System (DNS) lookup.

11. The network element of claim 1 further characterised in that the signal processing logic is further arranged to contact the address obtained in order to establish a connection with a network element supporting communication within the neighbouring cell.

12. The network element of claim 1 further characterised in that the network element comprises an Access Point (AP) for a femto cell.

13. The network element of claim 1 further characterised in that the cellular communication network comprises a Long Term Evolution (LTE) network

14. The network element of claim 1 further characterised in that the cellular communication network comprises a Universal Mobile Telecommunications System (UMTS) network.

15. A method for obtaining an address associated with a neighbouring cell of a cellular communication network, the method comprising the steps of:
reading system information broadcast within the neighbouring cell;
constructing a Fully Qualified Domain Name (FQDN) using the read system information; and
obtaining an address associated with the constructed FQDN.

16. A wireless communication system adapted to support a method for obtaining an address associated with a neighbouring cell of a cellular communication network of, comprising:
a processor operable to:
read system information broadcast within the neighbouring cell;
construct a Fully Qualified Domain Name (FQDN) using the read system information; and
obtain an address associated with the constructed FQDN.

17. A computer-readable storage element having computer-readable code stored thereon for programming signal processing logic to perform a method for obtaining an address associated with a neighbouring cell of a cellular communication network, the method comprising the steps of:
reading system information broadcast within the neighbouring cell;
constructing a Fully Qualified Domain Name (FQDN) using the read system information; and
obtaining an address associated with the constructed FQDN.

18. The computer-readable storage element of claim 17, wherein the computer readable storage medium comprises at least one of a hard disk, a CD-ROM, an optical storage device, a magnetic storage device, a ROM (Read Only Memory), a PROM (Programmable Read Only Memory), a EPROM (Erasable Programmable Read Only Memory), a EEPROM (Electrically Erasable Programmable Read Only Memory) and a Flash memory.
